(19) United States
(12) Patent Application Publication
(10) Pub. No.: US 2014/0353230 A1
(43) Pub. Date: Dec. 4, 2014

(54) Filter with heating medium and filter element of a filter

(71) Applicant: MANN+HUMMEL GMBH, Ludwigsburg (DE)

(72) Inventors: Martin Klein, Ludwigsburg (DE); Ralf Brunst, Ditzingen (DE); Claus Fischer, Fellbach (DE); Marco Goedecke, Freiberg (DE); Armando Labarta, Ludwigsburg (DE)

(73) Assignee: MANN+HUMMEL GMBH, Ludwigsburg (DE)

(21) Appl. No.: 14/290,529

(22) Filed: May 29, 2014

(30) Foreign Application Priority Data
Jun. 3, 2013 (DE) 10 2013 009 199.3

(51) Int. Cl. F02M 37/22; B01D 35/18; H05B 3/14

(52) U.S. Cl. CPC F02M 37/223; H05B 3/146; B01D 35/18
USPC 210/185; 219/553; 210/184

(57) ABSTRACT

A filter (10) and a filter element (18) for a fluid, particularly fuel, oil, water, air or urea solution, particularly of a combustion engine, particularly of an automobile, are described. The filter element (18) comprises a filter medium (20) through which fluid can flow. The filter element (18) further includes an electrically operated heating medium (30) that has at least one electrical resistor element with a temperature-dependent electrical resistor. The heating medium (30) is arranged in a path of flow (36) of the fluid in order to heat the fluid. The at least one resistor element includes an electrically conductive polymer composite that has a temperature-dependent electrical resistor.

### CROSS-REFERENCE TO RELATED APPLICATION

This application claims the benefit of German patent application No. 10 2013 009 199.3 filed Jun. 3, 2013, the entire contents of the aforesaid German patent application being incorporated herein by reference.

### TECHNICAL FIELD

The invention relates to a filter for a fluid, particularly fuel, oil, water, air or urea solution, particularly of a combustion engine, particularly of an automobile, with a filter medium through which fluid can flow, and an electrically operated heating medium that has at least one electrical resistor element with a temperature-dependent electrical resistor and is arranged in a path of flow of the fluid in order to heat the fluid.

Moreover, the invention relates to a filter element of a filter, particularly a filter according to the invention, for a fluid, particularly fuel, oil, water, air or urea solution, particularly of a combustion engine, particularly of an automobile, with a filter medium through which fluid can flow, and an electrically operated heating medium that has at least one electrical resistor element with a temperature-dependent electrical resistor and is arranged in a path of flow of the fluid in order to heat the fluid.

### BACKGROUND OF THE INVENTION

A filter device for fluids with an electrical heater for heating fluid that flows through the filter device for filtering is known from DE 10 2009 058 159 A1. A filter element is arranged in a filter housing. The heater has at least one heating web that encloses the filter element at least in part. It can have a positive temperature coefficient (PTC), so it is suited to implementing automatic regulation.

### SUMMARY OF THE INVENTION

An object of the invention to provide a filter and a filter element of the type mentioned at the outset in which the heating medium is arranged so as to maximize space-savings and has improved heating efficiency.

This object is achieved according to the invention in the filter in that the at least one resistor element comprises an electrically conductive polymer composite having a temperature-dependent electrical resistor.

According to the invention, the resistor element, in which electrical energy is converted into heat, is realized by means of an electrically conductive polymer composite. The resistor element can easily be manufactured in this way. A polymer composite enables great freedom of design with respect to the shape of the resistor element. The shape of the resistor element can be adapted optimally from the polymer composite to the available installation space and/or to the shape of the filter medium. Advantageously, thin webs can be implemented with the polymer composite in relation to their planar extension that can be arranged in a space-saving manner on an inflow side or an outflow side of the filter medium. Resistor elements can also be implemented from the polymer composite that have large inflow surfaces in relation to the required installation space. The larger the surface of the resistor element that is able to come directly or indirectly into contact with the heating medium, the better the heating efficiency of the heating medium. Accordingly, the resistor element can be operated with a lower heat output with the same heating of the fluid in order to achieve the same heating in the fluid. In this way, the electrical energy required to heat the fluid can be reduced. Through the temperature-dependent resistance characteristic of the polymer composite, automatic regulation of the thermal output of the at least one resistor element can be achieved that depends on the temperature of the fluid. A regulation device and/or a regulation method for controlling the thermal output of the heating medium can thus be simplified. Furthermore, the thermal output required at the installation site of the resistor element can thus be controlled individually and directly without the need for separate temperature sensors. With the at least one resistor element, positionally precise self-regulation and/or temperature restriction can be achieved, particularly with pinpoint accuracy. Furthermore, a thermal output can be adapted quickly, thus heating the fluid quickly. Moreover, using an arrangement of several such resistor elements, a dynamic energy distribution can be achieved in space, since the thermal output can be adapted to the surroundings.

Advantageously, electrically conductive areas of the heating medium can be electrically insulated from the fluid by means of an insulation material. In this way, an electrical current can be prevented from being conducted through the fluid. What is more, the insulation material can protect the conductive polymer composite from the fluid to be filtered, particularly fuel, preferably Diesel.

Advantageously, the filter medium and the heating medium can be parts of a filter element. In this way, the filter element can be preassembled with the filter medium and the heating medium as a modular component and installed into an appropriate filter housing. Alternatively, the heating medium can also be mounted in the filter housing independently of the filter element. It can be an exchangeable filter element that can be arranged in a filter housing that can be opened. A filter element can also be provided that is arranged firmly in an appropriate filter housing.

In an advantageous embodiment, the electrically conductive polymer composite can have an electrical resistor with a positive temperature coefficient. Advantageously, the electrically conductive polymer composite can have an intrinsic positive temperature coefficient. The electrically conductive polymer composite can have an intrinsic charge carrier density that is temperature-dependent. In this way, the automatic regulation of the at least one resistor element, which is dependent on the temperature of the fluid, can be further improved. An electrically conductive polymer composite can also be provided which, instead of the resistor with a positive temperature coefficient, has another type of temperature-dependent resistance. In particular, a resistor with a negative temperature coefficient can also be provided. Alternatively, the electrically conductive polymer composite can have, instead of a resistor with a positive temperature coefficient, a resistor with a negative temperature coefficient (NTC).

In another preferred embodiment, the electrically conductive polymer composite can be temperature-dependent in such a way that, starting at a temperature that lies below the ignition temperature of Diesel fuel, the resistance increases sharply.

Advantageously, a constant electrical voltage can be applied to the at least one resistor element. A current flows through the electrical resistor element that is dependent on its resistance. As the heating of the fluid and heating medium increases, the electrically conductive polymer composite increases as a result of the positive temperature coefficient. Consequently, the thermal output generated by the at least one resistor element drops as the temperature rises.

In another advantageous embodiment, the electrically conductive polymer composite can have an electrical resistor with an intrinsic positive temperature coefficient. The electrically conductive polymer composite therefore has an intrinsic PTC characteristic itself. In this way, self-regulation of the electrical resistor and hence of the thermal output can be achieved separately in every area of the polymer composite with pinpoint accuracy. Furthermore, temperature restriction can be implemented that has pinpoint accuracy.

In another advantageous embodiment, the heating medium can be embodied with the electrically conductive polymer composite as a heating web with at least one layer. At least two electrical contact lines can advantageously be arranged on or in the layer of the electrically conductive polymer composite with which electrical voltage can be applied to the electrically conductive polymer composite. The at least two contact lines can advantageously be made of metal, particularly copper or aluminum. The at least two contact lines can be embodied as wires or webs. The at least two contact lines can also be printed on the electrically conductive polymer composite. The at least two contact lines can be arranged with the electrically conductive polymer composite on the same side of the at least one layer. Alternatively, they can also be arranged on opposite sides of the layer of the electrically conductive polymer composite. Advantageously, the heating web with the at least one layer can be implemented in a kind of sandwich construction with the electrically conductive polymer composite and the at least two contact lines. In this way, respective temperature-dependent self-regulation of the electrical resistor can take place in one area of the heating web independently of each other, thus enabling positionally precise thermal output.

In another advantageous embodiment, the at least one resistor element can comprise an electrically insulating carrier material that is provided with the electrically conductive polymer composite. With the carrier material, the mechanical stability of the at least one resistor element can be increased. In this way, the requirements for the mechanical stability of the electrically conductive polymer composite can be reduced. Furthermore, the shapeability of the at least one resistor element can be improved. This has a positive effect on the freedom of design in relation to the shape of the resistor element. Preferably, the electrically conductive polymer composite can be applied to the carrier material as a paste, ink or film. In this way, thin polymer layers can be realized. The electrically conductive polymer composite can be applied to the carrier material easily and precisely using a printing process. Advantageously, the electrically insulating carrier material can be a textile-like composite, particularly a woven fabric, a warp-knitted fabric, a weft-knitted fabric, or a textile-like composite realized by means of embroidering, or a nonwoven fiber composite of another type. Nonwoven fiber composites can particularly be made of hot air-drawn plastic fibers (meltblown), spun fleece (spunbond) or a fleece of another type.

Furthermore, in another advantageous embodiment, at least two resistor elements can be separated electrically from each other by means of electrically insulating insulation elements. In this way, several resistor elements can be arranged in the path of flow of the fluid in a spatially distributed manner. The at least two resistor elements can regulate themselves automatically independently of each other. In doing so, the resistor elements can regulate themselves depending on the corresponding fluid temperature to which they are respectively exposed. In this way, the homogeneity of the temperature distribution in a flow space can be improved for the fluid.

In another advantageous embodiment, the heating medium can be a fiber composite with fibers or threads made of the electrically conductive polymer composite and electrically insulating fibers or threads. Advantageously, the heating medium can be a textile, particularly a woven fabric, a warp-knitted fabric, weft-knitted fabric, or a textile-like composite realized by means of embroidering. Alternatively, the heating medium can also be a fiber composite, particularly a fleece. Advantageously, the fibers or threads made of the electrically conductive polymer composite can be connected to the electrically insulating fibers or threads such that they are electrically insulated from each other. The fibers or threads electrically insulated from each other and made of the electrically conductive polymer composite can then be viewed as separate resistor elements that can regulate themselves more or less independently of each other.

According to another advantageous embodiment, the heating medium can be arranged in the path of flow in front of the filter medium. In this way, the fluid can be heated with the heating medium before it reaches the filter medium. The flowability of the fluid can be improved through heating. A pressure difference between an inflow side and an outflow side of the filter medium can thus be reduced.

In another advantageous embodiment, the heating medium can be web-like and have a plurality of flow-through openings for the fluid. The fluid is able to flow through the flow-through openings. The heating medium can thus be arranged in the path of flow transverse to a main flow of the fluid. The surface of the web-like heating medium through which the fluid flows can thus be enlarged. In this way, heat transfer can be improved. The electrical energy required can thus be improved. Advantageously, the heating medium can extend along the inflow side or the outflow side of the filter medium. Preferably, the heating medium can completely cover the inflow side or the outflow side of the filter medium. The homogeneity of the temperature distribution of the fluid in the flow space can thus be further improved. The flow-through openings can advantageously be larger than the largest particles, particularly contaminant particles, occurring in the fluid. The blocking of the flow-through openings by particles can be prevented in this way, thus increasing a pressure difference between an inflow side of the heating medium and an outflow side.

In another advantageous embodiment, the heating medium can be attached directly or indirectly to the filter medium, a filter element that comprises the filter medium, or a filter housing of the filter. In this way, the heating medium can be preassembled with the filter medium, the filter element or with the filter housing. The heating medium can be connected directly to the filter medium, the filter element or the filter housing. Alternatively, it can also be connected to the filter medium, the filter element or the filter housing indirectly by means of suitable fastening means.

In another advantageous embodiment, the heating medium can adjoin at least one end body of a filter element that comprises the filter medium. The at least one end body can serve to stabilize the filter element. What is more, the at least one end body can be designed to position and hold the filter element in the filter housing. When using a round filter element, the at least one end body can be an end disc. A stable attachment of the heating medium can be realized at the at least one end body.

In another advantageous embodiment, the heating medium can be attached at least with an edge tightly against the at least one end body. As a result, no fluid can flow between the edge of the heating medium and the at least one end body. In this way, forced flow of the fluid along the heating medium can be achieved.

In another advantageous embodiment, the heating medium can be attached at least to an edge via commensurate fastening means to the at least one end body. In this way, a gap or space between the edge of the heating medium and the at least one end body can be realized. This gap can advantageously serve as a bypass channel for the fluid to go around the heating medium. Particularly when using a heating medium with flow-through openings, the flow of fluid through the bypass channel can thus be enabled in the event of an operation-related blockage or obstruction.

In another advantageous embodiment, the heating medium can rest tightly against an inner wall of the filter housing or be embedded in it at least in part. Advantageously, when using a heating medium embodied as a heating web, it can be arranged in planar fashion against the inner wall of the filter housing. Particularly, the inner wall can be lined with the heating web over a large area. In this way, the maximum possible thermal output can be increased. Advantageously, the heating web can be in contact nearly completely with the fluid in the filter housing on one side. Advantageously, the heating web can be embedded in the inner wall of the filter housing at least in part. Advantageously, the heating web can be injection-coated by a material out of which the filter housing is made. Alternatively, the heating web can be adhered to the inner side of the filter housing. The heating web can advantageously be braced with an edge or rim in corresponding back-cuts or grooves in the filter housing. Advantageously, the heating web can be welded to the inner side of the filter housing. Advantageously, the inner side of the filter housing can have projecting and axially running nosepieces, and the heating web can have corresponding slots, and the heating web can be placed onto the nosepieces such that the nosepieces pass through the slots for the purpose of fastening. The filter housing can advantageously be made of plastic. The heating web can easily be embedded at least in part in plastic. With plastic, the heating web can also easily be welded. Back-cuts, grooves and/or nosepieces can easily be formed in plastic.

In another advantageous embodiment, the filter medium can be embodied as a hollow body through which fluid can flow from the inside to the outside or from the outside to the inside and can be enclosed at least in part on the outside by the heating medium, which can be embodied in the manner of a web, or which hollow body can enclose the web-like heating medium. Advantageously, the web-like heating medium can extend along an inflow side or an outflow side of the filter hollow body. In this way, uniform heating of the fluid in the flow space can be achieved.

Advantageously, the fluid can flow through the web-like heating medium, which can tightly enclose the filter hollow body. In this way, the fluid must pass through the heating medium, thus improving the homogeneity of the temperature distribution.

Alternatively, the web-like heating medium can advantageously be arranged at a distance from the inflow side or the outflow side of the filter hollow body, and the fluid can flow through the web-like heating medium. In this way, the fluid can flow through gaps between the heating medium and the filter hollow body. In this way, a heating medium can also be used through which fluid cannot flow, particularly one that does not have any flow-through openings. When using a heating medium through which fluid can flow, particularly one that has flow-through openings, bypass channels through which the fluid can flow can be realized through the spacing between the heating medium and the filter hollow body. As a result of the bypass channels, the fluid can go around the heating hollow body.

The filter hollow body can advantageously have the shape of a hollow cylinder or of a truncated cone. The filter element can be embodied as a so-called round filter element with a circular cylindrically shaped and circumferentially closed filter medium. Instead of a round cross section, the filter hollow body can also have another cross section, particularly an oval or angular cross section. Such filter elements also include so-called conical-oval round filter elements.

Advantageously, the heating medium can be embodied as a heating hollow body in which the filter hollow body can be arranged or that can be arranged in the filter hollow body. Advantageously, the heating hollow body can be geometrically similar to the filter hollow body. In this way, uniform flow spaces can be realized between the filter hollow body and the heating hollow body. This can have a positive effect on the uniform heating of the fluid. The heating hollow body and the filter hollow body can be arranged coaxially with respect to each other. The symmetry of the flow spaces can be improved in this way. This can have a positive effect on the flow of the fluid. Particularly, the flow of the fluid can thus be calmed. In this way, the heating of the fluid can be improved. Overall, the filtration and/or the heating of the fluid can be improved through appropriate adaptation of the shapes of the heating hollow body and the filter hollow body and/or their positioning with respect to each other.

Instead of a closed filter element with a filter hollow body, an open filter element can also be provided. Advantageously, it can be a so-called flat filter element, particularly a rectangular filter element. The heating medium can then advantageously also be implemented as an open heating web. The open heating web can advantageously extend along the inflow side or the outflow side of the open filter element transverse to a main flow direction of the fluid.

Advantageously, the filter medium can be zigzag shaped or folded in an undulating manner or bent. In this way, a larger filter surface can be realized in the same installation space. Alternatively, the filter medium can be unfolded.

The object is further achieved according to the invention in that the at least one resistor element comprises an electrically conductive polymer composite that has a temperature-dependent electrical resistance. All of the features and advantages cited in relation to the inventive filter apply to the inventive filter element, and vice versa. Advantageously, the filter element can be arranged in an exchangeable manner in a filter housing that can be opened. Alternatively, the filter element can be solidly arranged in the filter housing.

### BRIEF DESCRIPTION OF THE DRAWINGS

Additional advantages, features and detail of the invention follow from the description below, in which exemplary embodiments of the invention are explained in further detail with reference to the drawing. The person skilled in the art will also view the features disclosed in combination in the drawing, the description and the claims individually and group them together into additional expedient combinations. Schematic figures:

FIG. 1 shows a longitudinal section of a fuel filter with a round filter element having a filter bellows that is enclosed by an electrically operated heating jacket according to a first exemplary embodiment;

FIG. 2 shows a top view of a heating web out of which the heating jacket from FIG. 1 is bent;

FIG. 3 shows a not-to-scale section of the heating web from FIG. 2 along the section line III-III;

FIG. 4 shows a longitudinal section of a fuel filter with a round filter element with a heating jacket according to a second exemplary embodiment;

FIG. 5 shows a longitudinal section of a fuel filter with a round filter element with a heating jacket according to a third exemplary embodiment;

FIG. 6 shows a longitudinal section of a fuel filter with a round filter element with a heating jacket according to a fourth exemplary embodiment; and

FIG. 7 shows a longitudinal section of a fuel filter with a round filter element with a heating jacket according to a fifth exemplary embodiment.

In the figures, same components are provided with same reference symbols.

### DETAILED DESCRIPTION

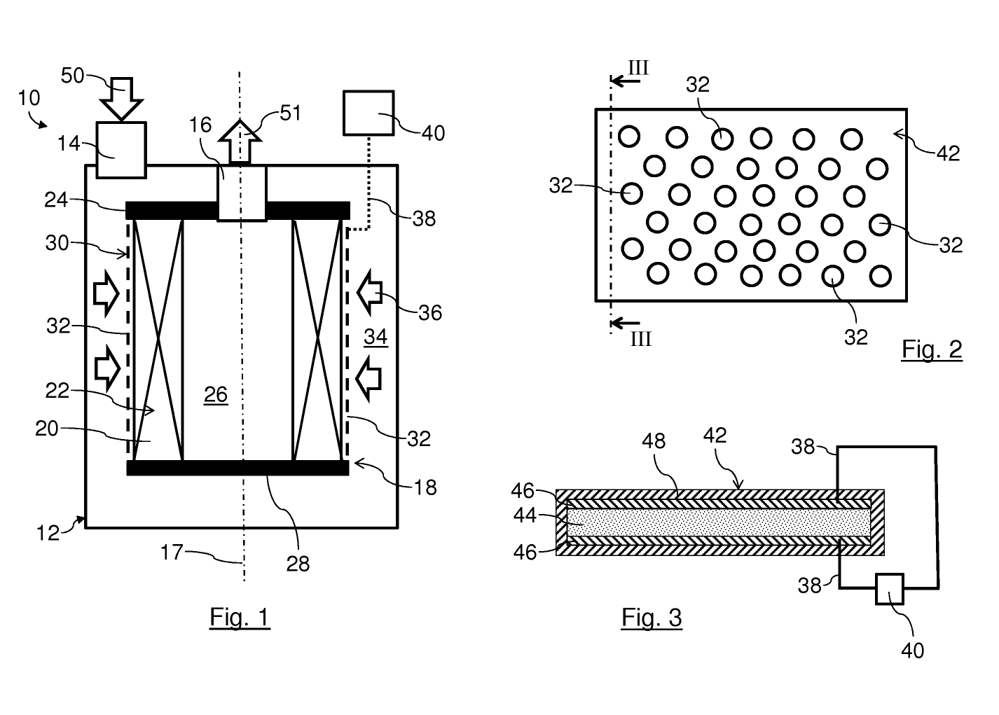

FIG. 1 shows a fuel filter 10 in a schematic, not-to-scale sectional representation. The fuel filter 10 can be arranged in a manner that is not of further here in a fuel line of a combustion engine of an automobile. The fuel filter 10 can be flowed through in order to clean the fuel.

The fuel filter 10 comprises a filter housing 12 with an inlet 14 for fuel to be cleaned and an outlet 16 for cleaned fuel. The outlet 16 is centrally arranged in what is the upper side of the filter housing 12 in FIG. 1. The outlet 16 is coaxial to an imaginary filter axis 17. The inlet 14 is eccentrically placed in the upper side of the filter housing 12. In the following, “axial,” “radial,” “coaxial” or circumferential” refer to the filter axis 17 unless specified otherwise.

A round filter element 18 is firmly arranged coaxially in the filter housing 12 such that is tightly separated the inlet 14 from the outlet 16. The round filter element 18 comprises a filter medium 20 made of fleece, for example cellulose with meltblown, that is folded in a zigzag shape into a star-shaped filter bellows 22 and closed circumferentially. The filter bellows 22 has the overall shape of a hollow circular cylinder. On its side facing toward the outlet 16, the filter bellows 22 is tightly connected to a connecting end plate 24. The connecting end plate 24 has a coaxial opening through which the outlet 16 is connected to an interior space 26 of the round filter element 18. On the front side opposite the outlet 16, the round filter element 18 is tightly connected to a closed connecting end plate 28.

The filter bellows 22 is enclosed radially on the outside by a coaxial heating jacket 30, which has the shape of a hollow circular cylinder. A diameter of the heating jacket 30 is somewhat larger than the radially outside diameter of the filter bellows 22 and somewhat smaller than the radially outside diameter of the connecting end plate 24 and of the connecting end plate 28. The heating jacket 30 is closed circumferentially. It extends in the axial direction from the connecting end plate 24 to the connecting end plate 28. The heating jacket 30 is respectively near the connecting end plate 24 and connecting end plate 28 with its respective front edge. In this way, the heating jacket 30 can be preassembled with the round filter element 18 and inserted into the filter housing 12 together with the round filter element 18.

The heating jacket 30 has a plurality of flow-through openings 32. The fuel can pass through the flow-through openings 32 from an inlet annular space 34, which encloses the filter bellows 22 radially on the outside on its inflow-side raw side, radially toward the inside, indicated by arrows 36, to an outlet-side clean side of the filter bellows 22 in the interior space 26. The flow-through openings 32 are arranged in a distributed manner circumferentially and in the axial direction. The diameter of the flow-through openings 32 are so large that they offer as little flow resistance as possible even with viscous fuel, when the fuel temperature is low, for example. Preferably, the flow-through openings 32 are larger than the largest particles contained in the fuel that are to be filtered out of the fuel with the fuel filter 10. In this way, it can be prevented that the flow-through openings 32 are obstructed by contaminant particles.

The heating jacket 30 is electrically operated. It is connected to a power supply unit 40 of the combustion engine via electrical lines 38, which are indicated with dotted lines in FIG. 1. The power supply unit 40 can be part of an engine control, for example. It can also be a separate power supply unit.

The heating jacket 30 consists of a rectangular heating web 42, which is shown in FIGS. 2 and 3, which is bent into a circular cylinder and closed at opposing end sections. The heating jacket 30 can also have a support structure (not shown). In FIG. 3, the heating web 42 is shown in a section which, for the sake of clarity, is not to scale. The heating web 42 comprises a conductive polymer layer 44. Arranged on both sides of the conductive polymer layer 44 is a respective contact layer 46. The contact layers 46 are made of an electrical conductor, metal, for example, preferably copper or aluminum. Each of the contact layers 46 is connected to the power supply unit 40 via a corresponding electrical line 38. In this way, electrical voltage can be applied to the contact layers 46, so that electrical current can flow through the conductive polymer layer 44.

The sandwich-like arrangement of the conductive polymer layer 44 and the contact layers 46 is enclosed by an insulation material 48 which brings about an electrical insulation against the fuel that flows later against the heating jacket 30. The insulation material 48 can consist, for example, of polyamide (PA) or polyester (PE) or another electrically insulating material or material mix. The flow-through openings 32, not shown in FIG. 3, traverse the conductive polymer layer 44, the contact layers 46 and the insulation material 48. Preferably, the insulation material also extends along the inner walls of the flow-through openings 32, so that the polymer layer 44 and the contact layers 46 are also electrically insulated outwardly toward the fuel in the interior region of the flow-through openings 32.

When the combustion engine is in operation, the fuel to be filtered flows from the fuel line via the inlet, indicated in FIG. 1 by an arrow 50, into the inlet annular space 34. From the inlet annular space 34, the fuel flows through the heating jacket 30 through the flow-through openings 32 from radially on the outside to radially on the inside. The fuel is in thermal contact with the heating jacket 30 on the radially outer circumferential side, the radially inside circumferential side of the heating jacket 30 and within the flow-through openings 32. Depending on a temperature of the fuel and of the heating jacket 30, an electrical resistance of the polymer layer 44 changes. When the combustion engine is in operation, a constant electrical voltage is applied by means of the power supply unit 40 to the contact layers 46. A current flows through the conductive polymer layer 44, thus heating the heating jacket 30. The heat is transferred from the heating jacket 30 to the incoming fuel. As a result, the flowability of the fuel increases. The fuel flows through the flow-through openings 32 and reaches the filter bellows 22. The heated fuel flows through the filter bellows 22 from radially on the outside to radially on the inside and is cleaned with the filter medium 20. The cleaned fuel passes on the clean side of the filter medium 20 into the interior space 26. The fuel flows out of the interior space 26 out of the fuel filter 10, indicated in FIG. 1 by an arrow 51, and reaches the fuel line.

As the heating of the fuel and of the heating jacket 30 increases, the electrical resistance of the conductive polymer layer 44 increases as a result of the positive temperature coefficient. As the temperature rises, the thermal output generated by the heating jacket 30 drops. In this way, the temperature of the fuel in the fuel filter 10 is regulated automatically.

FIG. 2 shows the fuel filter 10 with a heating jacket 130 according to a second exemplary embodiment. The second exemplary embodiment differs from the first exemplary embodiment in that the diameter of the heating jacket 130 is larger than the outer diameter of the connecting end plate 24 and the connecting end plate 28. For this reason, a connection-side annular gap 152 is therefore realized appropriately between the connection-side front side of the heating jacket 130 and the connecting end plate 24. Via fastening means (not shown), the heating jacket 130 can be connected to the connecting end plate 24 and the connecting end plate 28.

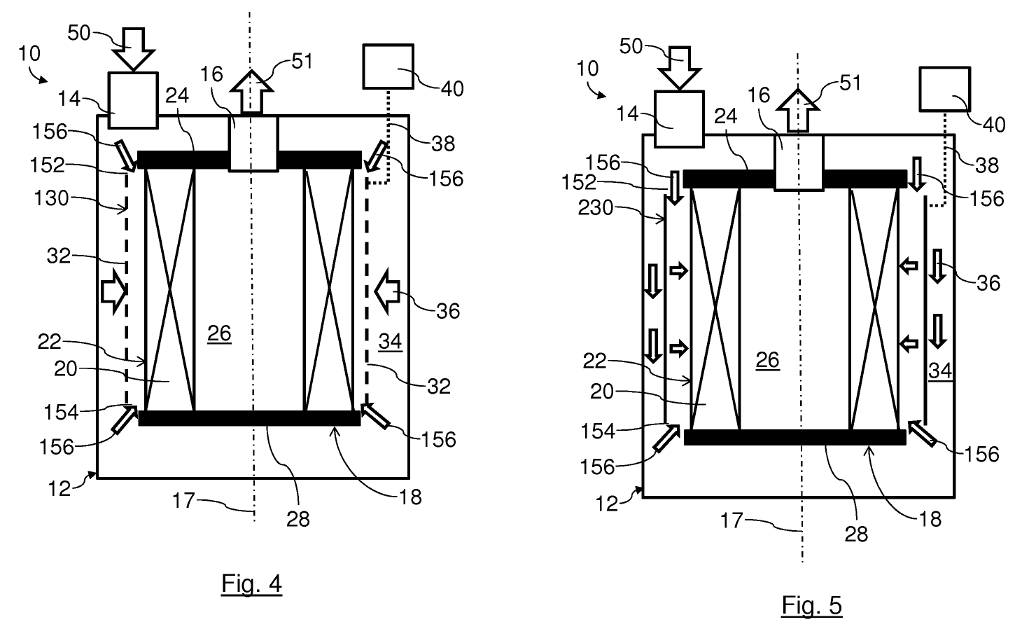

In addition or alternatively, when the combustion engine is in operation, the fuel can pass from the inlet annular space 34 to the flow-through openings 32 through the annular gaps 152 and 154 to the inlet side of the filter bellows 22. This is indicated by arrows 156. The fuel is thus able to go around the flow-through openings 32. In this way, a kind of bypass is realized that enables flow of fuel in the event of blockage or obstruction of the flow-through openings 32, for example. Otherwise, the functionality of the fuel filter 10 according to the second exemplary embodiment from FIG. 4 corresponds to the functionality of the first exemplary embodiment from FIGS. 1 to 3.

FIG. 5 shows the fuel filter 10 with a heating jacket 230 according to a third exemplary embodiment. The third exemplary embodiment differs from the first exemplary embodiment from FIGS. 1 to 3 and the second exemplary embodiment from FIG. 4 in that the heating jacket 230 does not have any flow-through openings 32 in the third exemplary embodiment. Otherwise, the heating jacket 230 corresponds in its structure and functionality to the heating jacket 30 according to the first exemplary embodiment from FIGS. 1 to 3 and to the heating jacket 130 from the second exemplary embodiment from FIG. 4. Like in the second exemplary embodiment, the diameter of the heating jacket 230 is larger than the diameter of the connecting end plate 24 and the connecting end plate 24 and the connecting end plate 28, so that the annular gaps 152 and 154 are realized here, too.

When the combustion engine is in operation, the fuel flows against the heating jacket 230 on its radially outer circumferential side. The fuel passes exclusively through the annular gaps 152 and 154 to the radially inner circumferential side of the heating jacket 230. The fuel is in thermal contact with the heating jacket 230 on the radially outer and the radially inner circumferential side of the [heating jacket 230]. Otherwise, the functionality of the fuel filter 10 according to the third exemplary embodiment from FIG. 5 corresponds to the functionality of the two preceding exemplary embodiments from FIGS. 1 to 3 and FIG. 4.

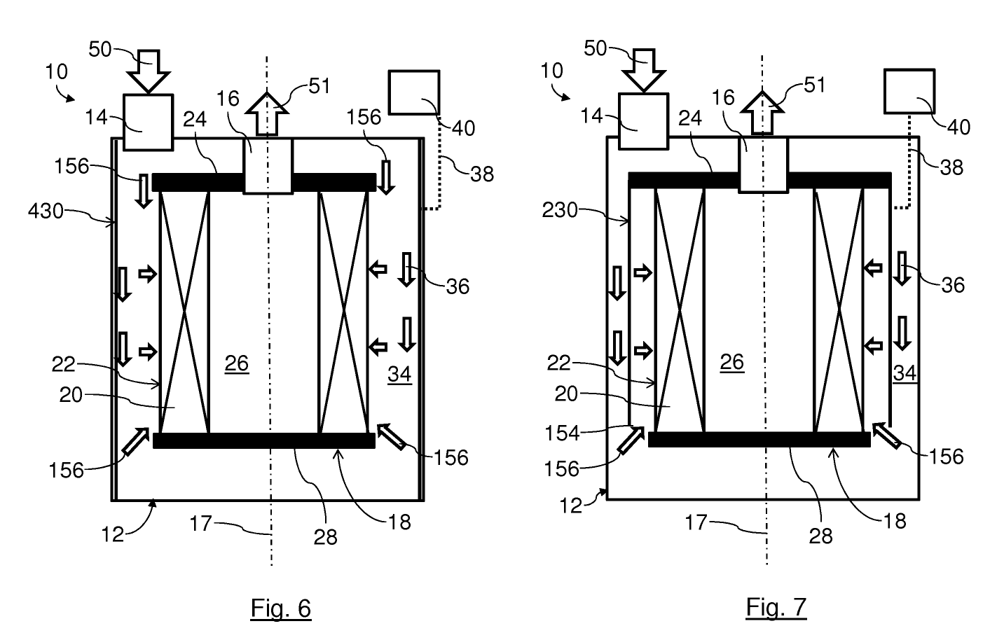

FIG. 6 shows the fuel filter 10 with a heating jacket 430 according to a fourth exemplary embodiment. The fourth exemplary embodiment differs from the first, second and third exemplary embodiments from FIGS. 1 to 5 in that, in the fourth exemplary embodiment, the heating jacket 430 is not connected to the round filter element 18, but to the filter housing 12. Otherwise, the heating jacket 430 corresponds in its structure and its functionality to the heating jacket 30 according to the first exemplary embodiment from FIGS. 1 to 3, the heating jacket 130 according to the second exemplary embodiment from FIG. 4 and the heating jacket 230 from the third exemplary embodiment from FIG. 5. Similarly to the heating web 42 from FIGS. 2 and 3, the heating web of the heating jacket 430 can respectively be with or without flow-through openings 32; 332. The heating web of the heating jacket 430 is arranged in planar fashion against the radially inner circumferential side of the filter housing 12. The radially inner circumferential side of the filter housing 12 is nearly completely lined with the heating web of the heating jacket 430. In addition or alternatively, a bottom and/or a lid of the filter housing 12 can be lined in planar fashion with a corresponding heating web. On its radially outer circumferential side, the heating jacket 430 is injection-coated with the plastic material of the filter housing 12. With its radially inner circumferential side, the heating jacket 430 is completely in thermal contact with the fuel flowing through.

Instead of being injection-coated with the plastic of the filter housing 12, the heating web of the heating jacket 430 can be adhered to the inner wall of the filter housing. Alternatively or in addition, the heating web can also be braced with an edge or rim in corresponding back-cuts or grooves in the filter housing. The heating web can be welded to the inner side of the filter housing. The inner side of the filter housing can also have axially running nosepieces projecting in the radial direction, and the heating web can have corresponding slots, and the heating web can be placed onto the nosepieces such that the nosepieces pass through the slots for the purpose of fastening.

FIG. 7 shows the fuel filter 10 with a heating jacket 230 according to a fifth exemplary embodiment. The fifth exemplary embodiment differs from the third exemplary embodiment from FIG. 5 in that the diameter of the connecting end plate 24 is as large as the diameter of the heating jacket 230. The heating jacket 230 is tightly attached to the connecting end plate 24. Unlike the third exemplary embodiment, the annular gap 152 there is omitted.

In all of the above-described exemplary embodiments of a filter 10 and of a filter element 18, the following modifications are possible, among others:

The invention is not limited to fuel filters 10 of combustion engines of automobiles. They can also be used outside of automobile engineering, for example in industrial motors. Nor is the invention limited to filters for fuels. Rather, it can also be used in filters for other types of fluids, such as oil, water, air or urea solution. The invention can also be used independently of combustion engines.

Instead of the round filter element 18, another type of filter element can also be provided. It can be a filter element embodied as a hollow body which, instead of a round cross section, can have an oval or angular cross section. Instead of the cylindrical shape, the filter element can also have another shape, for example a conical shape. Instead of the filter element 18 embodied as a hollow body, an open filter element, for example a flat filter element, can be provided.

Instead of being folded in the shape if a zigzag, the filter medium 20 can also be bent circumferentially in another way. For example, the filter medium 20 can be folded in an undulating manner or bent. The filter medium 20 can also be unfolded.

Instead of the fleece, another type of filter medium can also be provided, such as a foam or a medium composite.

Instead of being fixed, the round filter element 18 can also be arranged in the filter housing 12 such that it is exchangeable. For this purpose, the filter housing can have an appropriate way to be opened.

As the conductive polymer layer 44 or for the heating threads 344, another type of electrically conductive polymer composite can also be used that has a resistor with a positive temperature coefficient. The resistor can have a positive intrinsic temperature coefficient. An electrically conductive polymer composite can also be provided which, instead of the resistor with a positive temperature coefficient, has a resistor that is temperature-dependent in another way.

In the heating web 42, instead of the contact layers 46, other types of contact lines, for example wires or webs, can also be provided. More than two contact layers can also be provided. Instead of being arranged on opposing surfaces, the contact layers 46 can also be arranged on the same side of the polymer layer 44.

More than one polymer layer 44 and more than two contact layers 46 can be provided, which can be arranged in a sandwich structure.

Instead of the multilayer heating web 42 or the woven heating web 342, a heating web with an electrically insulating carrier material can also be provided that is provided with an electrically conductive polymer composite. For example, the electrically conductive polymer composite can be applied to the carrier material as a paste, ink or film. The electrically conductive polymer composite can be applied to the carrier material using a printing process, for example. The electrically insulating carrier material can be a textile-like composite, particularly a woven fabric, a warp-knitted fabric, a weft-knitted fabric, or a textile-like composite realized by means of embroidering, or a nonwoven fiber composite of another type, for example. Nonwoven fiber composites can particularly be made of hot air-drawn plastic fibers (meltblown), spun fleece (spunbond) or a fleece of another type. The fleece can particularly contain cellulose.

Instead of the heating web 42; 432, at least two PTC resistor elements of another type can be provided with an electrically conductive polymer composite having a resistor with a particularly intrinsic positive temperature coefficient, which can be separated from each other electrically by means of electrically insulating insulation elements.

Instead of the woven heating web 342, a fiber composite of another type can also be provided with fibers or threads made of an electrically conductive polymer composite and electrically insulating fibers or threads. The fiber composite can be another kind of textile, for example a warp-knitted fabric, a weft-knitted fabric, or a textile-like composite realized by means of embroidering. Alternatively, a nonwoven fiber composite, for example a fleece, can be provided. The fleece can particularly contain cellulose.

The heating threads 344 can also be made of another type of electrically conductive polymer composite with a resistor with a positive temperature coefficient.

Instead of flowing through the filter bellows 92 from radially on the outside to radially on the inside, fuel can also flow through it from radially on the inside to radially on the outside. In that case, the heating jacket can preferably be arranged in the interior space 26 so that the fuel can be heated before it reaches the filter medium.

Instead of being circumferentially closed, the heating jacket 30; 130; 230; 430 can also have interruptions.

Instead of being arranged on the inflow side of the filter bellows 22, the heating jacket 30; 130; 230; 430 can also be arranged on the outflow side of the filter bellows 22. In that case, the fuel can be heated after flowing through the filter medium 20.

Instead of being constant, the electrical voltage applied to the contact layers 46 can also be controlled or regulated by the power supply unit 40 in dependence on an operating state of the combustion engine, for example.

The heating jacket 30; 130; 230 can also be connected to the connecting end plate 24 and/or the connecting end plate 28 of the round filter element 18. Alternatively or in addition, the heating jacket 30; 130; 230 can also be connected to the filter bellows 22. For instance, it can rest against the folds of the filter bellows 22 and be connected to it.

Instead of being connected to the round filter element 18, the heating jacket 30; 130; 230 can also be attached separately from it, via support elements to the filter housing 12, for example.

Alternatively, the heating jacket 30; 130; 230 can also extend in the axial direction over only a partial length of the round filter element 18.

1. A filter (10) for a filtering a fluid of a combustion engine, comprising:
a filter medium (20) for filtering the fluid; and
an electrically operated heating medium (30; 130; 230; 342; 430) including
at least one electrical resistor element (44; 344) with a temperature-dependent electrical resistor, the at least one electrical resistor element (44; 344) arranged in flow path (36; 256) of the fluid and heating the fluid;
wherein the at least one resistor element comprises
an electrically conductive polymer composite (44; 344) that has the temperature-dependent electrical resistor.

2. The filter according to claim 1, wherein
the electrically conductive polymer composite (44; 344) has an electrical resistor with a positive temperature coefficient.

3. The filter according to claim 1, wherein
the electrically conductive polymer composite (44; 344) has an electrical resistor with an intrinsic positive temperature coefficient.

4. The filter according to claim 1, wherein
the heating medium (30; 130; 230; 430) is embodied as a heating web (42) with at least one layer (44) with the electrically conductive polymer composite.

5. The filter according to claim 1, wherein
the at least one resistor element comprises
an electrically insulating carrier material that is provided with the electrically conductive polymer composite.

6. The filter according to claim 1, wherein
at least two resistor elements (344) are electrically separated from each other by means of electrically insulating insulation elements (438, 349).

7. The filter according to claim 1, wherein
the heating medium (30; 130; 230; 342; 430) is arranged in the flow path (36; 156) in front of the filter medium (20).

8. The filter according to claim 1, wherein
the heating medium (30; 130; 342) is web-like having a plurality of flow-through openings (32; 332) extending through the heating medium for the fluid.

9. The filter according to claim 1, wherein
the heating medium (30; 130; 230; 430) is attached directly or indirectly to
the filter medium (20), or
a filter element (18) which comprises the filter medium (20), or
a filter housing (12) of the filter (10).

10. The filter according to claim 1, wherein
the heating medium (30; 130; 230) is attached to at least one end body (24, 28) of a filter element (18);
wherein the filter element includes the filter medium (20).

11. The filter according to claim 10, wherein
the heating medium (30) adjoins the at least one end body (24, 28) with at least one edge.

12. The filter according to claim 11, wherein
the heating medium (30; 130; 230) is attached to the at least one end body (24, 28) at least on one edge via appropriate fastening means.

13. The filter according to claim 11, wherein
the filter medium (20) is embodied as a hollow body (22) through which fluid can flow from the inside to the outside or from the outside to the inside;
wherein the filter medium (20) is least partially enclosed on the outside by the web-like heating medium (30; 130; 230; 342; 430) or encloses the web-like heating medium.

14. A heating element of a filter (10) filtering a fluid, wherein
the heating element has an electrically operated heating medium (30; 130; 230; 342; 430) that has at least one electrical resistor element (44; 344) with a temperature-dependent electrical resistor and
wherein the heating element is arranged in a flow path (36; 256) of the fluid to heat the fluid;
wherein the at least one resistor element comprises
an electrically conductive polymer composite (44; 344) that has a temperature-dependent electrical resistor.

15. A filter element (18) for a filter according to claim 1, comprising:
a filter medium (20) through which fluid can flow to be filtered;
an electrically operated heating medium (30; 130; 230; 342; 430) that has at least one electrical resistor element (44; 344) with a temperature-dependent electrical resistor, and that is arranged in a path of flow (36; 256) of the fluid in order to heat the fluid;
wherein the at least one resistor element includes
an electrically conductive polymer composite (44; 344) that has a temperature-dependent electrical resistor.
